(19) United States
(12) Patent Application Publication
(10) Pub. No.: US 2016/0065828 A1
(43) Pub. Date: Mar. 3, 2016

(54) METHOD FOR CONTROLLING ELECTRONIC DEVICE USING IP CAMERA HAVING FUNCTION OF WIRELESS REMOTE CONTROLLER

(71) Applicant: HONESTTECHNOLOGY CO., LTD, Yooseong-gu Daejeon (KR)

(72) Inventor: Soo Woo Lee, Daejeon (KR)

(21) Appl. No.: 14/648,895

(22) PCT Filed: Nov. 6, 2013
(86) PCT No.: PCT/KR2013/010028

§ 371 Date: Jun. 1, 2015

(30) Foreign Application Priority Data
May 22, 2013 (KR) 10-2013-0057483

(51) Int. Cl. H04N 5/232

(52) U.S. Cl. CPC H04N 5/23206

(57) ABSTRACT

A networked camera for controlling electronic devices is provided. The camera includes a camera module for obtaining images, a remote control module for generating remote control signals for electronic devices, and a module for controlling orientation of the remote control module. The remote control module includes an IR (infrared) beam emitter for generating IR remote control signals. In response to a control command from a user device, the camera identifies a target electronic device, an orientation associated with the target electronic device. The camera changes orientation of a remote control module toward the target electronic device using the identified orientation and transmit an IR control signal for controlling the target electronic device.

### TECHNICAL FIELD

Described embodiments relate to a method for operating an electronic device using an IP camera system, and more particularly, to a controlling method of an electronic device using an IP camera with a wireless remote-control capability. The IP camera with a remote-control capability acquires image data of an area of interest day and night; controls the electronic devices that are located in the area of interest remotely; and provides simplified procedure of inputting new data that the IP camera will need to learn and process in order to remotely control electronic devices.

### BACKGROUND ART

Generally, an Internet Protocol (IP) camera is used for surveillance purpose by detecting or monitoring intrusion into outdoor territories, domiciles, or offices.

The IP camera is installed at a location where surveillance is necessary. A user can connect to the IP camera by connecting to a communication server with a personal terminal (e.g., smartphone, desktop PC, laptop PC, etc.) via the Internet. The user can then control pan/tilt or zoom functions of the IP camera, or view images captured through the IP camera on a real-time basis remotely.

With its image-capturing function, the IP camera can monitor the outward condition of an electronic device such as air conditioner, TV, and so on, but the IP camera does not have capability to operate the devices, for example, an ability to turn on or off the electronic devices outside the house.

Meanwhile, the technology of integrated remote-management of electronic devices has been suggested which proposes to connect the electronic devices to a networking device for communication there between so that the electronic devices are controlled externally at a remote distance. However, this suggestion has a shortcoming of increased network setup cost.

### RELATED ARTS

[Document 1] KR Patent No. 0954375, entitled “Intelligent video management system”

[Document 2] KR Patent Publication No. 2011-0133709, entitled “System and method for remote access control to home network”

### DETAILED DESCRIPTION OF THE INVENTION

### Technical Problem

A technical aspect of the present disclosure is to provide a method for controlling an electronic device using an IP camera with a wireless remote controlling function which is capable of monitoring an area of interest based on images acquired from the IP camera while concurrently controlling the electronic device at a remote distance by using at least one of a plurality of IR LEDs mounted to the surveillance IP camera as an IR remote control to control the electronic device.

Another technical aspect of the present disclosure is to provide a method for controlling an electronic device using an IP camera with a wireless remote controlling function which can simplify a procedure of registering data to be learned for controlling the electronic device using the IP camera system at a remote distance through a user terminal.

### Technical Solution

According to an embodiment of the present invention, a method for controlling an electronic device using an Internet protocol (IP) camera with a wireless remote controlling function is provided. The method may include steps of: in response to a request signal for learning a remote control signal and a remote control signal for learning that is received from the IP camera, learning a remote control signal of the electronic device by matching the received remote control signal for learning with a remote control menu item, by the IP camera, receiving a learned control signal for the electronic device from the user terminal and registering the same, and in response to a remote control signal of the electronic device from the user terminal, controlling by the IP camera operation of the electronic device based on the learned information.

The process of learning at the user terminal may include receiving a learning request signal, receiving a signal to select an electronic device as a target device of learning, displaying on a screen a remote control information and a remote control menu item corresponding to the electronic device for which the learning is requested, transmitting control signal for an electronic device to the IP camera according to a user input signal, determining whether or not the electronic device operates in accordance with the user input signal based on an information acquired by the IP camera, and when the electronic device is determined to be operating in accordance with the user input signal, downloading a corresponding remote control signal information from outside.

Further, the process of learning at the user terminal may include receiving a learning request signal, receiving a signal to select an electronic device requested for learning, displaying on a screen the remote control menu item necessary for controlling the electronic device selected for learning, receiving a plurality of remote control signals for learning one after another at the IP camera, assigning an identification code for each of the received remote control signal and displaying the identification code on the screen, transmitting, in response to a user manipulation signal, at the IP camera, the remote control signal for which the identification code is assigned such that the electronic device is controlled, and matching the identification code with the remote control menu item displayed on the screen in response to a user manipulation signal.

Further, the process of learning at the user terminal may include receiving a learning request signal, receiving a signal to select an target electronic device, receiving a remote control signal to be learned via the IP camera, and registering a menu name corresponding to the received remote control signal in accordance with a user manipulation signal.

Further, the process of learning at the user terminal may additionally include receiving a signal to select an IP camera, and receiving pan/tilt information of the selected IP camera and registering the same in association with the identification information of a target electronic device.

The process at the user terminal of receiving the signal to select target electronic device for learning may include acquiring a shape information of the target electronic device from a camera captured image and causing the electronic device to be automatically identified and selected using a pattern matching between the acquired shape information of the electronic device and a pre-set shape information.

Further, the method may include controlling operation of the IP camera in accordance with a control request from the user terminal and transmitting an obtained image to the user terminal, receiving a remote control signal from the user terminal, reading and obtaining an electronic device control signal by matching the received remote control signal with the learned information, and then controlling the operation of the electronic device in accordance with the obtained control signal.

Further, the process of controlling the operation of the electronic device, at the IP camera, may include receiving the remote control signal from the user terminal, reading and obtaining an IP camera actuation control signal and an electronic device control signal by matching the received remote control signal with the learned information, controlling actuation of the IP camera in accordance with the recovered IP camera actuation control signal, and controlling the operation of the electronic device in accordance with the obtained electronic device control signal.

Also, the method may include transmitting, at the IP camera, information about an operating electronic device based on an acquired image information or sound information to the user terminal, and the IP camera may calculate a pan/tilt information of the IP camera based on location information of a control target electronic device and the IP camera and control the operation of the IP camera based on the calculated pan/tilt information of the IP camera.

Further, the IP camera may perform the steps of acquiring a sound signal outputted from the electronic device requested for controlling through a microphone, calculating a location of the electronic device requested for controlling, angle information between the electronic device requested for controlling, and the IP camera based on the sound signal acquired through the microphone, calculating a pan/tilt information of the IP camera based on the location, the angle information as calculated, and controlling the actuation of the IP camera in accordance with the calculated pan/tilt information of the IP camera.

### Advantages of the Invention

According to embodiments of the present disclosure, it is possible to obtain an enhanced efficiency of energy management while externally controlling electronic devices remotely without an additional communication network between a network device and the electronic devices by using one of a plurality of IR LEDs amounted to a surveillance IP camera as an IR remote-control for controlling the electronic devices.

Further, the embodiments of the present disclosure advantageously enhance function of the IP camera by utilizing the IP camera to control electronic devices remotely as well as perform surveillance.

Furthermore, user convenience is also increased as the process of registering remote-control-function-learning data of the IP camera is simplified.

### BRIEF DESCRIPTION OF THE DRAWINGS

FIG. 1 illustrates configuration of an IP camera system employing a wireless remote controlling function according to an embodiment of the present disclosure;

FIG. 2 is a perspective view of the IP camera of FIG. 1;

FIG. 3 illustrates configuration of the IP camera of FIG. 1;

FIG. 4 is a flowchart provided to explain a learning method of an IP camera system employing a wireless remote-control capability according to an embodiment of the present disclosure;

FIG. 5 is a flowchart provided to explain a method for learning electronic-device remote-control information and registering the learned data according to a first method of a present disclosure;

FIG. 6 is a flowchart provided to explain a method for learning electronic-device remote-control information and registering the learned data according to a second method of a present disclosure;

FIG. 7 is a flowchart provided to explain a method for learning electronic-device remote-control information and registering the learned data according to a third method of a present disclosure;

FIG. 8 is a flowchart provided to explain a method for controlling an electronic device from an IP camera system that employs a wireless remote controlling function according to a first embodiment of the present disclosure; and

FIG. 9 is a flowchart provided to explain a method for controlling an electronic device from an IP camera system employing a wireless remote controlling function according to a second embodiment of the present disclosure.

### DETAILED DESCRIPTION OF THE EMBODIMENTS

To fully understand the purpose achieved by the embodiments of the present invention and operational advantages thereof, reference is made to the appended drawings illustrating preferred embodiments of the present invention and also to the contents shown in the drawings.

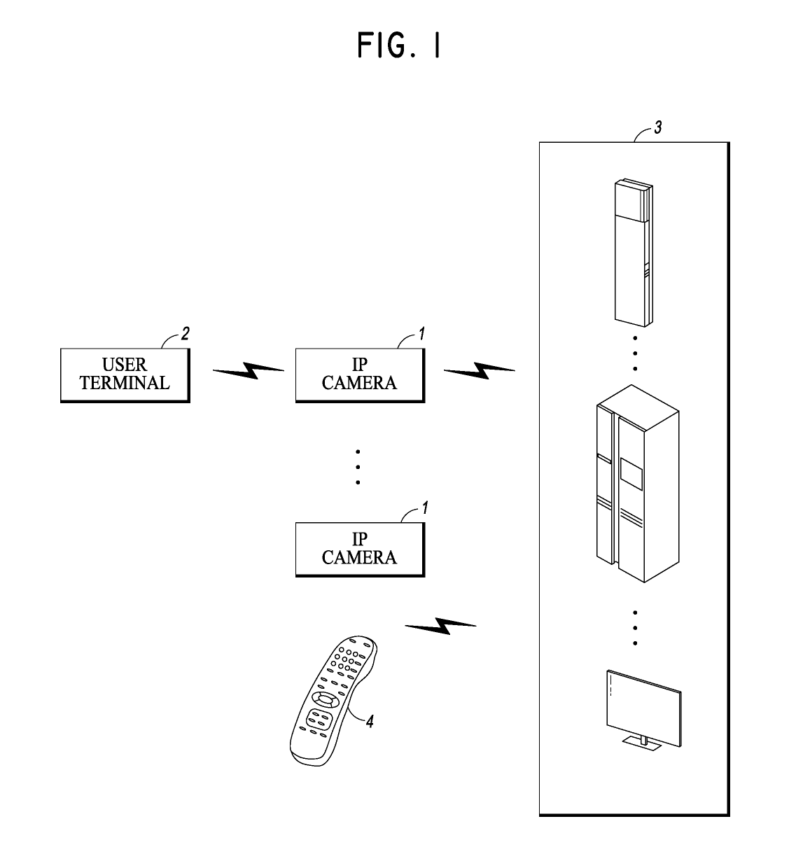

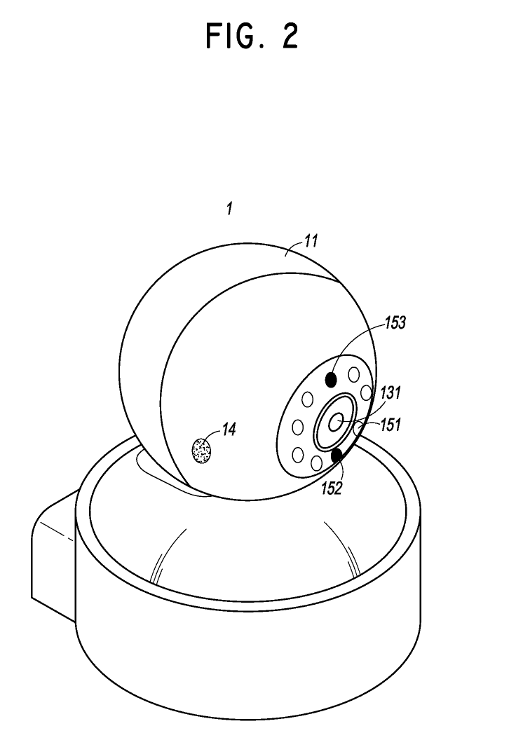

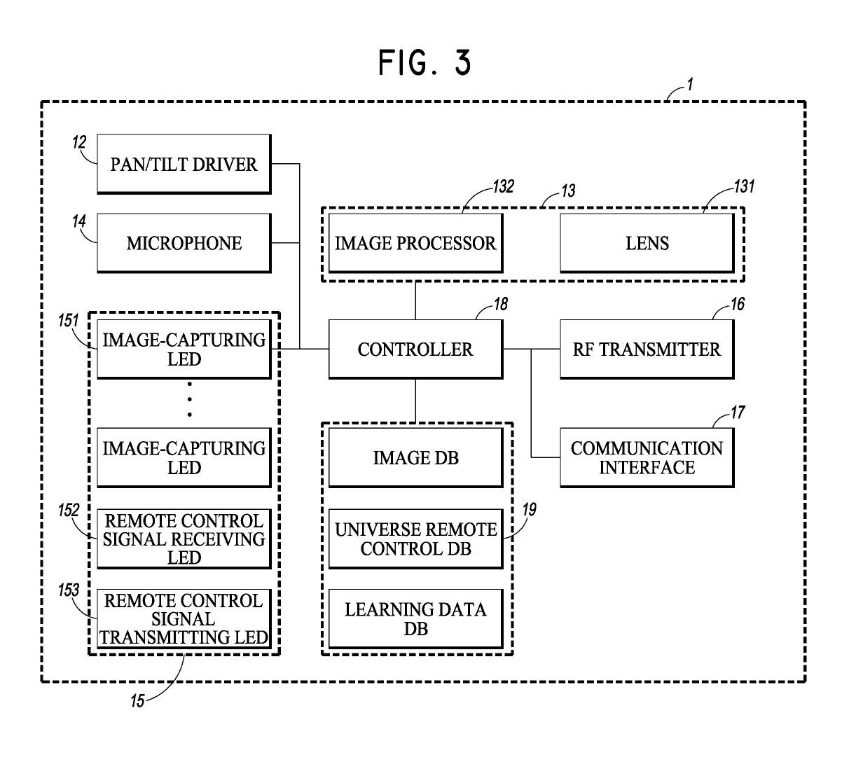

FIG. 1 illustrates a configuration of an IP camera system employing a wireless remote controlling function according to an embodiment of the present disclosure; FIG. 2 is a perspective view of the IP camera of FIG. 1, and FIG. 3 illustrates a configuration of the IP camera of FIG. 1.

Referring to FIGS. 1 to 3, the IP camera system employing a wireless remote controlling function according to an embodiment includes a plurality of IP cameras 1, a user terminal 2, a plurality of electronic devices 3 and a remote control 4.

The IP cameras 1 acquires image data of a location the IP cameras 1 are installed, transmit the acquired data to the user terminal 2 or send out a control signal to control the electronic devices 3 in response to an external control signal, and learn and store information to control the electronic devices 3 according to a user setting.

When requested by the user terminal 2 to capture image in real-time, the IP cameras 1 provide the current real-time image to the user terminal 2, or compress and store a captured image in a memory 17 and provide the compressed image to the user terminal 2 upon being requested by the user terminal 2.

IP camera 1 includes a body 11, a pan/tilt actuator 12, an image acquirer 13, a microphone 14, an LED 15, an RF transmitter 16, a communication interface 17, a controller 18, and a database 19.

The body 11 is installed such that operation of the pan/tilt actuator 12 is controlled in accordance with an externally-received control signal or an operation signal received from an operation unit which is separately installed on the body 11.

The image acquirer 13 is provided to acquire image data of surroundings of the body 11 and includes a lens 131 provided on a front surface of the body 11 as well as an image processor 132 configured to receive the light entering through the lens 131 and generates a image with an image processing method.

The microphone unit 14 is provided to acquire, from an audio signal, operation status, volume, location or direction of the electronic device, or presence, location or direction of a person, or the like, and to trace a sound source by calculating direction and distance of the sound source based on intensity, phase difference, and time associated with the sound source detected through two microphones. Each microphone employs a bi-directional microphone that has directivity to a specific direction, rather than an omni-directional microphone.

The LED module 15 includes a plurality of LEDs 151 for image capturing, a LED 152 for receiving remote control signal, and a LED 153 for transmitting remote control signal.

The plurality of LEDs 151 for image-capturing are arranged in an annular fashion around the front lens 131 of the body 11. The plurality of LEDs 151 for image-capturing do not operate when it is bright enough to meet the required level of illumination for image capturing, while the LEDs 151 operate when it is dark at night (i.e. when the required level of illumination for image capturing is not met) to allow infrared image capturing to be performed.

The LED 152 for receiving remote control signal is provided for a remote-controlling-function-learning process (to be explained below) in which when the user presses a key on the remote control 4, the LED 152 for receiving remote control signal receives an infrared signal sent from the remote control 4. The LED 153 for transmitting remote control signal is configure to transmit an infrared signal to control the operation of a corresponding electronic device 3 in accordance with a received control signal, when the control signal is received from the user terminal 2.

Meanwhile, not all the electronic devices used at home are infrared-controllable. For example, it is not possible to infrared-control a digital door lock as the digital door lock is only controllable with an RF signal. Accordingly, an aspect of the present disclosure additionally includes an RF transmitter 16, which sends out an RF signal to control the electronic devices 3 that react exclusively to the RF signals. Meanwhile, unlike the infrared signal, the RF signal does not have directivity. Accordingly, the install location of the RF transmitter 16 is not limited, and may be any place inside or outside the body 11 of the IP camera 1.

The communication interface 17 is provided for data transmission and reception with the user terminal 2, and for control of the electronic devices 3 by a wired or wireless method other than an infrared method, and includes a wireless communication module and a wired communication module.

In response to a control signal received from the user terminal 2, the controller 18 controls the pan/tilt of the IP camera 1 or operation of the electronic devices 3, based on a previously configured information in the memory 17 and in accordance with the control signal.

In addition to the image DB 191 for storing captured images, the database 19 includes a universe remote control DB 192 and a leaning data DB 193 for storing information necessary for the control of the electronic devices 3.

The universe remote control DB 192 stores control signal information corresponding to manufacturer's information, product information and remote control menu of the control target electronic device for facilitating the remote-control-signal-learning process. That is, the universe remote control DB 192 enhances learning convenience, as the universe remote control DB 192 allows the user to select and store only wanted menu icons from the remote control menus displayed on a screen rather than to operate through all the menu buttons of the remote control to set the information. The information on the universe remote control is accessible to the user terminal 2 through a webpage or downloadable via an application.

The learning data DB 193 stores remote control signal information of the respective electronic devices and pan/tilt control information of the IP cameras, location information of the IP cameras and the electronic devices, or the like.

That is, in order to control each electronic device, different infrared signals are used depending on manufacturer's product models and supported functions. Further, because infrared signal has directivity, the control signal is limited to a predetermined range of angles. Accordingly, to ensure effective control on the control target electronic device, it is necessary to store pan/tilt information of the IP camera which can place the electronic device within the infrared signal reception range as well as to store the control signal information that matches the respective electronic devices.

To that end, the user can have remote control signal information corresponding to the remote controlling functions of the electronic device stored in the universe remote control DB 192 as well as the IP camera pan/tilt information to be learned and stored in in the learning data DB 193. the user can have remote control signal information acquired by direct operation of menu buttons on remote control of the electronic device as well as the pan/tilt information to learned and stored in the learning data DB 193. The method for remote-control-learning will be explained in detail below.

Meanwhile, the user terminal 2 connected to the IP cameras 1 by a wired or wireless communication network externally controls the operation of the IP cameras 1 and plays a role of monitoring the images captured through the IP cameras 1 at a remote distance. The user terminal 2 may be a portable terminal such as a smartphone, a laptop computer, or a desktop PC.

To be specific, the user terminal 2 may externally control the pan/tilt of the IP cameras 1 in response to a user's operation signal to change the direction of image capturing when the user wants to monitor an image in certain direction, or may input learning information required for controlling of the electronic device 3, or may transmit a control signal in accordance with the user's operation signal to the IP cameras 1.

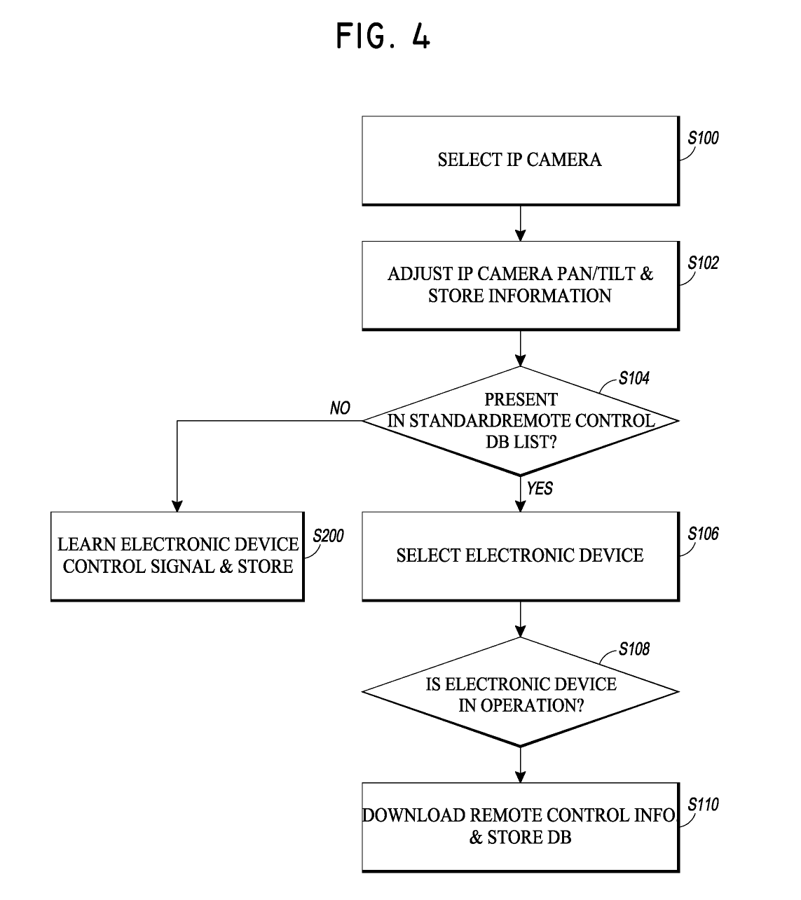

FIG. 4 is a flowchart provided to explain a learning method of an IP camera system employing a wireless remote controlling function according to an embodiment of the present disclosure. The learning method will be explained below with reference to FIGS. 1 to 3.

First, with the user terminal 2 the user executes an IP camera control program and selects a remote control registration menu.

Accordingly, a list of IP cameras 1 appears on the screen and the user selects an IP camera 1 to control the electronic device 3 intended for learning (S100). the user adjusts the pan/tilt of the selected IP camera 1 while viewing the images displayed on a screen of the user terminal 2, and when completing adjusting the pan/tilt, stores the pan/tilt information by matching it with the ID of the corresponding electronic device 3 (S102). The pan/tilt adjustment needs to be done in a way that the transmission range of the infrared signal of remote control signal transmitting LED 153 with directivity of the IP camera is aligned with the angle of infrared light reception of the electronic device and that image information and sound information for monitoring of the operational status of the electronic device 3 can be received.

It is determined if the corresponding electronic device 3 is in a list of the universe remote control DB 192 (S104), and if so, the corresponding electronic device 3 is selected from the list (S106). The screen may display the product model of the electronic device or the manufacturer, thus allowing the user to select the product model and the manufacturer in an order. Selecting the electronic device 3 may be directly done by the user from the list or, rather than direct selecting, an alternative embodiment may acquire the shape of the electronic device with the camera and automatically identify and select the model of the electronic device based on the acquired shape information.

After selecting the electronic device 3 from the list, the user presses one of the icons displayed on the screen, and when noting the corresponding electronic device to be in power-on/off state or to be in operation (S108), the user causes downloading and storing of the remote control information by matching it with the IP camera information and the IP camera pan/tilt information acquired at S100 and S102 (S110).

Meanwhile, when it is determined that the corresponding electronic device 3 is not present in the list of the universe remote control DB 192 at S104, while the user operating the remote control the remote control signals can be learned, via the IP camera, and stored.

The process of the learning and storing involves the user inputting information about the electronic device using a keypad screen, step-wise learning of control signals that match the remote control menus of the corresponding electronic device, and storing the control signals. The information of the electronic device may include i product information and manufacturer information which may be directly inputted in a text form by the user or selected by the user from a list.

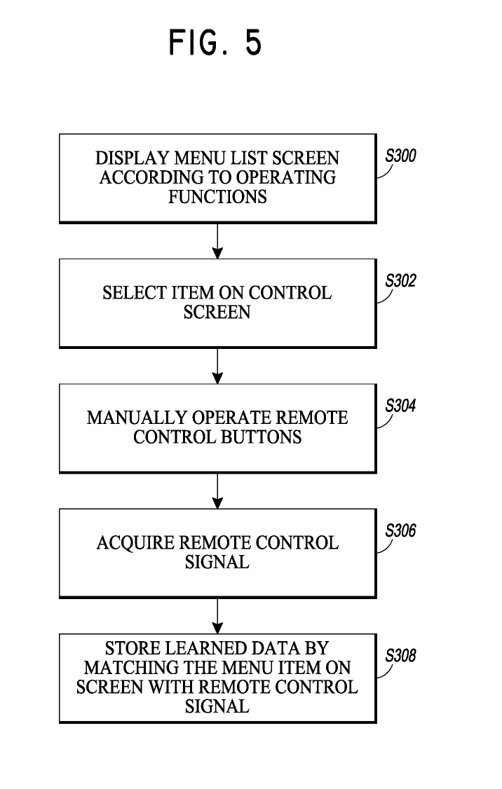

FIG. 5 is a flowchart illustrating a method of learning electronic-device remote-control information and registering the learned data according to a first method of the present invention.

First, when a product of the electronic device is selected, a menu list corresponding to the operational functions of the corresponding electronic device is displayed on a screen (S300).

Then, the user selects a necessary item from the menu list on the screen (S302), and presses a menu button of the remote control 4 that matches the corresponding item toward the IP camera 1 (S304).

As an infrared signal of the remote control 4 is received at the LED for receiving remote control signal 152 of the IP camera 1, a remote control signal for learning is acquired (S306).

When the remote control signal for learning is acquired at the step S306, the user cause storing of the learned data by matching the item on the screen (S308).

After that, the operation from the step S302 to the step S308 are repeated until learning of the desired menu item is completed.

According to the first learning method of the present invention, the learning process can be simplified since the user does not have to input the remote control menu items one by one as text.

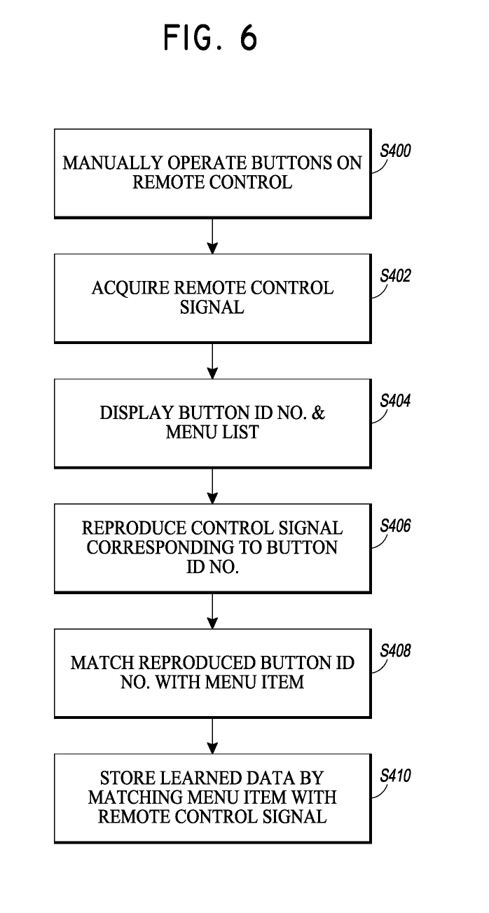

FIG. 6 is a flowchart illustrating a method for learning electronic-device remote-control information and registering the learned data according to a second method of a present disclosure.

First, when the user presses the remote control button toward the IP camera (S400), a remote control signal for learning is acquired as an infrared signal of the remote control 4 is received from the LED 152 for receiving remote control signal of the IP camera 1 (S402). At this time, the user presses all the buttons on the remote control 4 in order, so that all the remote control signals for learning can be acquired.

The remote control menu list necessary to drive the corresponding electronic device appears on the screen along with a button identification number (ID No.)(S404).

Then, as the user presses the button ID Nos. on the screen in order, thereby reproduces control signals and then identifies type of the control signals based on operational status of the electronic device (S406), and matches the button ID Nos. with menu items, respectively (S408). For example, when the user identify power-on/off in case No. “2” code (given an ID No.) was selected, the user may drag and match the ID No. “2” code to the “power” item. Accordingly, the infrared signal generated by pressing ID No. “2” matches with the “power” item, which simplifies the learning data setting as the user is not required to input the text information about the remote control menu item.

When matching the button ID Nos. and the menu items is completed, the learned information that matches the items on the screen and the remote control signals is stored (S410).

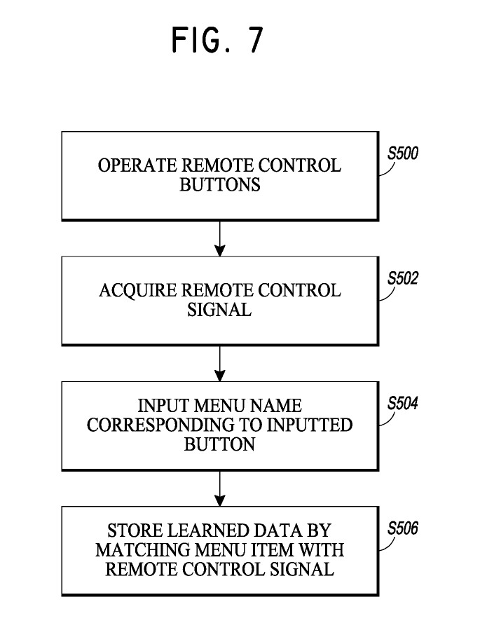

FIG. 7 is a flowchart provided to explain a method for learning electronic-device remote-control information and registering the learned data according to a third method of a present disclosure.

First, when the user presses a remote control button toward the IP camera (S502), a remote control signal for learning purpose is received via the remote control signal receiving LED 152 of the IP camera 1.

When, the user terminal 2 receives a remote control signal for learning from the IP camera 1 (S502), the user inputs a menu name so that the user can identify information about the function that corresponds to the pressed remote control button (S504). Although the operating the remote control button is performed prior to inputting a menu name, in another embodiment it is possible to input the menu name and to operate the remote control button subsequently.

When operating the button on the remote control and inputting menu names are completed, learning is completed and the learned data of matching between the items on the screen and the remote control signals is stored (S506).

Herein below, a method for controlling an electronic device at an IP camera system employing a wireless remote controlling function according to an embodiment of the present disclosure will be explained.

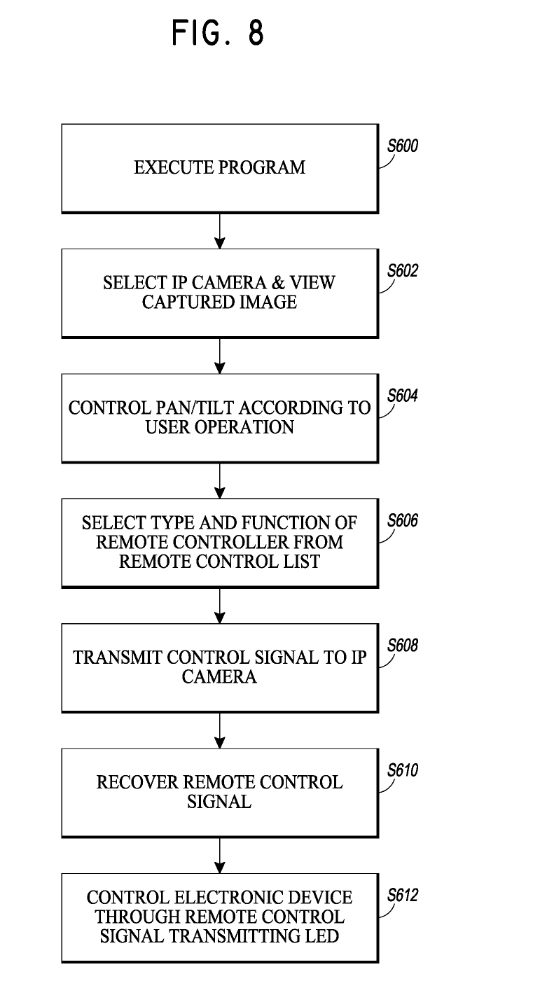

FIG. 8 is a flowchart provided to explain a method for controlling an electronic device at an IP camera system that employs a wireless remote controlling function according to a first embodiment of the present disclosure. Accordingly, embodiments will be explained below with reference to FIG. 8, along with FIGS. 1 to 3.

Referring to FIG. 8, first, an IP camera list appears on a screen as the user executes an electronic device control program (S600), and the user selects an IP camera and an image captured through the IP camera is displayed on the screen (S602).

At this time, the user terminal displays the operational status of the electronic device on a screen thereof as well as image information about the electronic device. The operational status of the electronic device may be recognized based on light emitting status of a display panel provided in the electronic device or a manufacturer name or a product name appearing on the image, or in the case of a TV or an audio equipment, based on the audio information inputted through a microphone provided in the IP camera 1.

It is possible to automatically recognize the currently-operated electronic device before the user selects an IP camera, and, in order to do so, relative location information between the IP cameras and the electronic devices or shape information needs be set in advance. That is, it is necessary to identify the electronic device in order to detect the operational status of the electronic device based on the panel light emitting status or audio information of the electronic device and notify the operational status of a corresponding electronic device. Accordingly, the embodiments of the present disclosure set in advance the shape information of the electronic devices, extract shape of the electronic device from the image acquired through the IP camera, and identifies the type of the electronic device by matching patterns between the extracted shape and preset shape information. Alternatively, it is possible to calculate distance between the IP camera and the electronic device and locations based on the audio information generated from the electronic device and identify the electronic device by matching the calculated result with the preset location information.

Meanwhile, while observing the screen of the user terminal 2, the user adjusts pan/tilt of the IP camera 1 so that the remote control transmitting LED 153 is directed toward the electronic devices 3 (S604).

When the pan/tilt adjustment of the IP camera 1 is completed, the electronic-device-remote-control menus are displayed on the screen. The user selects a desired remote control from the displayed list and selects a desired function from the menu list of the remote control (S606).

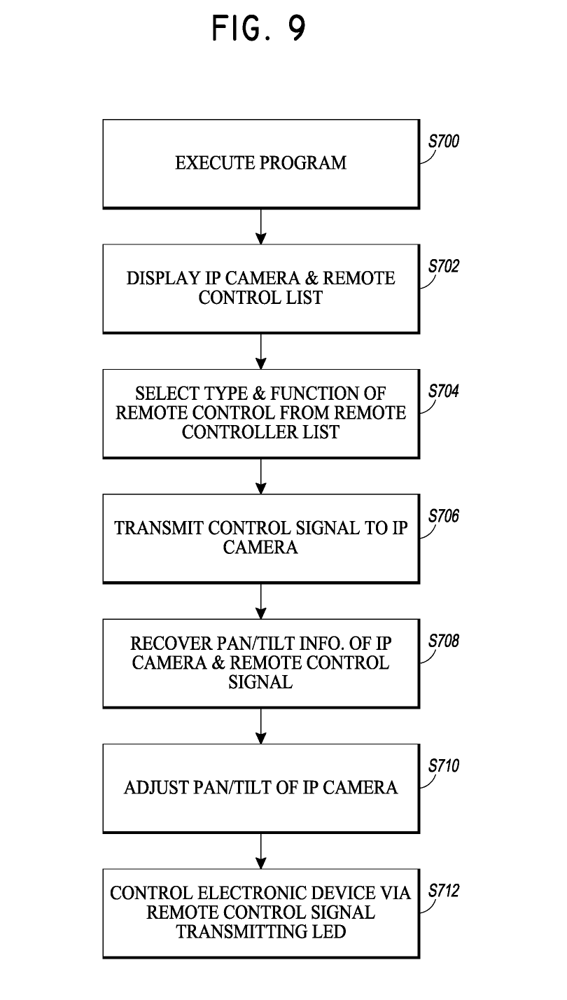

In one embodiment, the user may select a remote control from the screen of the user terminal, but not limited thereto. That is, selecting a remote control may be performed automatically. Accordingly, when the IP camera 1 is selected, the IP camera 1 captures images of the electronic devices within a recognition range, and the user terminal 2 may automatically identify the electronic devices based on the manufacturer names or product names marked on the electronic devices from the captured images, or may extract shape information of the electronic devices, match patterns between the extracted shape information and preset shape information, and automatically identify the electronic device so that the remote controls corresponding to the electronic devices are automatically selected. This automatic selecting of a remote control may be equally applicable to not only the first embodiment of FIG. 9 but also the second embodiment of FIG. 10.

The user terminal 2 sends out the inputted signal to the IP camera 1 (S608), and the IP camera 1 recovers the stored remote control signal from the database based on the received control signal (S610).

After that, the IP camera 1 transmits the remote control signal to the electronic device 3 via the remote control signal transmitting LED 153 to thus control the operation of the electronic device 3 (S612).

### Embodiments of the Invention

FIG. 9 is a flowchart provided to explain a method for controlling an electronic device at an IP camera system employing a wireless remote controlling function according to a second embodiment of the present disclosure. Accordingly, embodiments will be explained below with reference to FIG. 9, along with FIGS. 1 to 3.

Referring to FIG. 9, first, as the user executes an electronic device control program (S700) a list of IP cameras and a list of remote controls are displayed on a screen (S702).

After that, the user selects a desired remote control from the displayed list and also selects a desired function from a menu list of the remote control (S704).

The user terminal 2 sends the inputted signal to the IP camera 1 (S706), and the IP camera 1 recovers the IP camera 1 pan/tilt information and the remote control signal from the database based on the received control signal (S708).

The pan/tilt information of the IP camera 1 may be previously determined for individual control target electronic devices or may be calculated based on preset relative positions or angle information between the IP camera 1 and the electronic devices 3.

The IP camera 1 automatically adjusts the pan/tilt according to the recovered pan/tilt information (S710), and sends out a remote control signal via the remote control signal transmitting LED 153 to the electronic devices 3 to thus control operation of the electronic devices 3 (S712).

The pan/tilt information of the IP camera 1 may be controlled according to predetermined information, but in another embodiment it is possible to detect, in real-time, the location of the control target electronic device and calculate the pan/tilt information based on the detected location.

Accordingly, it is possible to obtain the location of the electronic devices and angle information between the electronic devices and the IP camera by acquiring sound signals outputted from the control target electronic devices through two microphones and by calculating direction and distance between the IP camera and the electronic devices based on the intensity and phase difference or time regarding sound source detected by two microphones.

Accordingly, pan/tilt information of the IP camera for controlling electronic devices can be obtained without setting pan/tilt information of the IP camera corresponding to the control target electronic devices or location information of the electronic devices in advance.

Moreover, the embodiments of the present disclosure may additionally include a method for automatically adjusting pan/tilt of the camera based on the location and distance information between the electronic devices and the IP camera when an error in the pan/tilt information is accumulated due to change deliberately made in the pan/tilt of the camera or repetition of the operation.

While the present invention has been described with reference to a preferred embodiment shown in the drawings this is merely an example and it will be understood to those skilled in the art that various modifications and variations can be made from the above description. Accordingly, the scope of the present invention should be determined by the technical concept of the following claims.

### INDUSTRIAL APPLICABILITY

The present disclosure relates to a camera system that is externally accessible via a communication network which is applicable in the industrial field to enhance security and convenience by enabling a user to externally view the images acquired through the camera, and also to remote-control an electronic device with the camera.

1. A method for controlling an electronic device using an Internet protocol (IP) camera having a wireless remote controlling function and the method comprising steps of:
receiving, at a user terminal, a request signal for learning a remote control signal, a remote control signal for learning purpose from the IP camera, and learning a remote control signal of the electronic device by matching the received remote control signal for learning purpose with a remote control menu item; and
receiving, at the IP camera, the learned electronic device control signal from the user terminal and registering the same, and when receiving the remote control signal of the electronic device from the user terminal, controlling driving of the electronic device based on the learned data.

2. The method of claim 1, wherein the step of learning at the user terminal comprises:
receiving a learning request signal;
receiving a signal to select an electronic device requested for learning;
displaying on a screen remote control information and the remote control menu item corresponding to the electronic device for which the learning is requested;
transmitting an electronic device control signal to the IP camera according to a user input signal;
determining whether or not the electronic device is operating in accordance with the user input signal based on an information acquired through the IP camera, and when determining that the electronic device is operating in accordance with the user input signal, downloading a corresponding remote control signal information from outside.

3. The method of claim 1, wherein the step of learning at the user terminal comprises:
receiving a learning request signal;
receiving a signal to select an electronic device requested for learning;
displaying on a screen the remote control menu item necessary for controlling the electronic device requested for learning;
receiving a plurality of remote control signals for learning purpose from the IP camera in sequence, assigning an identification code per received remote control signal for learning purpose, and displaying on the screen;
transmitting to the IP camera the remote control signal for learning purpose assigned with the identification code in accordance with an operating signal from a user so that controlling on the electronic device is performed; and
matching the identification code with the remote control menu item displayed on the screen in accordance with the operating signal from a user.

4. The method of claim 1, wherein the step of learning at the user terminal comprises:
receiving a learning request signal;
receiving a signal to select an electronic device requested for learning;
receiving a remote control signal for learning purpose from the IP camera; and
registering a menu name corresponding to the received remote control signal for learning purpose in accordance with an operating signal from a user.

5. The method of claim 1, wherein the step of learning at the user terminal further comprises:
receiving a signal to select an IP camera; and
receiving a pan/tilt information of the selected IP camera and registering the same by matching it with the identification information of a corresponding electronic device.

6. The method of claim 1, wherein the step at the user terminal of receiving the signal to select the electronic device requested for learning comprises acquiring a shape information of the electronic device requested for learning by camera image-capturing and causing the electronic device to be automatically identified by matching patterns between the acquired shape information of the electronic device and a preset shape information.

7. The method of claim 1, wherein the step at the IP camera of controlling the driving of the electronic device comprises:
controlling the driving of the IP camera in accordance with a control request from the user terminal and transmitting a captured image to the user terminal;
receiving from the user terminal the remote control signal;
recovering an electronic device control signal by matching the received remote control signal with the learned data and controlling the driving of the electronic device in accordance with the recovered control signal.

8. The method of claim 1, wherein the step at the IP camera of controlling the driving of the electronic device comprises:
receiving from the user terminal the remote control signal;
recovering an IP camera driving control signal and an electronic device control signal by matching the received remote control signal with the learned data;
controlling the driving of the IP camera in accordance with the recovered IP camera driving control signal; and
controlling the driving of the electronic device in accordance with the recovered electronic device control signal.

9. The method of claim 7, further comprising transmitting, at the IP camera, information about the electronic device operating based on an acquired image information or sound information to the user terminal.

10. The method of claim 8, comprising calculating, at the IP camera, a pan/tilt information of the IP camera based on a location information of the electronic device requested for controlling the IP camera wherein the driving of the IP camera is controlled based on the calculated pan/tilt information of the IP camera.

11. The method of claim 8, comprising acquiring, at the IP camera, a sound signal outputted from the electronic device requested for controlling through a microphone, calculating a location of the electronic device requested for controlling and an angle information between the electronic device requested for controlling, and the IP camera based on the sound signal acquired through the microphone, and calculating a pan/tilt information of the IP camera based on the location and the angle information as calculated wherein the driving of the IP camera is controlled in accordance with the calculated pan/tilt information of the IP camera.
